(19) United States
(12) Patent Application Publication
(10) Pub. No.: US 2015/0002437 A1
(43) Pub. Date: Jan. 1, 2015

(54) TOUCH-SENSITIVE DISPLAY DEVICE AND TOUCH-SENSITIVE DEVICE

(71) Applicant: WINTEK CORPORATION, Taichung City (TW)

(72) Inventors: WEN-CHUN WANG, TAICHUNG CITY (TW); CHUN-CHIA LIU, FONGYUAN CITY (TW); ZHI-TING YE, MIAO LI COUNTY (TW)

(21) Appl. No.: 14/485,230

(22) Filed: Sep. 12, 2014

Related U.S. Application Data
(63) Continuation of application No. 12/791,611, filed on Jun. 1, 2010.

(30) Foreign Application Priority Data
Jun. 2, 2009 (TW) 098118307

(51) Int. Cl. G06F 3/041; G02B 3/00; G06F 1/16

(52) U.S. Cl. CPC G06F 3/0412; G06F 1/1643; G02B 3/00; G02B 2003/0093
USPC 345/173

(57) ABSTRACT

A touch-sensitive display device includes a display, a lens, and a touch-sensitive element. The lens is positioned above the display, where a surface of the lens is divided into a periphery region and a central region, the central region is planar, and the periphery region is non-planar. The touch-sensitive element is disposed between the lens and the display.

### CROSS-REFERENCE TO RELATED APPLICATION

This application is a continuation of U.S. patent application Ser. No. 12/791,611, filed Jun. 1, 2010.

### BACKGROUND OF THE INVENTION

(a) Field of the Invention

The invention relates to a touch-sensitive display device having frameless visual effect.

(b) Description of the Related Art

Typically, a conventional display has a non-active frame region that is formed on its periphery and fails to display images, and the frame region is reserved for assembly purposes or the placement of mechanisms. The existence of the frame region may deteriorate the visual effect of a display, and the visual effect is deteriorated to a greater extent as the area of the frame region becomes larger. Hence, there has been a recent trend towards a high-quality display having narrow-frame visual effect or even frameless visual effect.

### BRIEF SUMMARY OF THE INVENTION

One object of the invention is to provide a touch-sensitive display device capable of performing touch-sensitive operations and having frameless visual effect.

According to an embodiment of the invention, a touch-sensitive display device includes a display, a lens, and a touch-sensitive element. The lens is positioned above the display, where a surface of the lens is divided into a periphery region and a central region, the central region is planar, and the periphery region is non-planar. The touch-sensitive element is disposed between the lens and the display.

In one embodiment, the periphery region of the lens forms a curved surface or an inclined plane.

In one embodiment the touch-sensitive element is integrally formed under the lens as one piece or integrally formed on the display as one piece.

In one embodiment, the touch-sensitive display device further includes at least one optical film formed on one surface of the lens facing the touch-sensitive element, and the index of refraction of the optical film is smaller than the index of refraction of the lens.

### BRIEF DESCRIPTION OF THE DRAWINGS

FIG. 1 shows a schematic diagram of a touch-sensitive display device according to an embodiment of the invention.

FIG. 2 shows a schematic diagram illustrating different shapes of a lens.

FIG. 3 shows a schematic diagram of a touch-sensitive display device according to another embodiment of the invention.

FIG. 4 shows a schematic diagram of a touch-sensitive display device according to another embodiment of the invention.

FIG. 5A shows a schematic diagram of a touch-sensitive display device according to another embodiment of the invention.

FIG. 5B shows a schematic diagram of a touch-sensitive display device according to another embodiment of the invention.

FIG. 6 shows a schematic diagram of a lens structure according to another embodiment of the invention.

FIG. 7 shows a schematic diagram of a lens structure according to another embodiment of the invention.

### DETAILED DESCRIPTION OF THE INVENTION

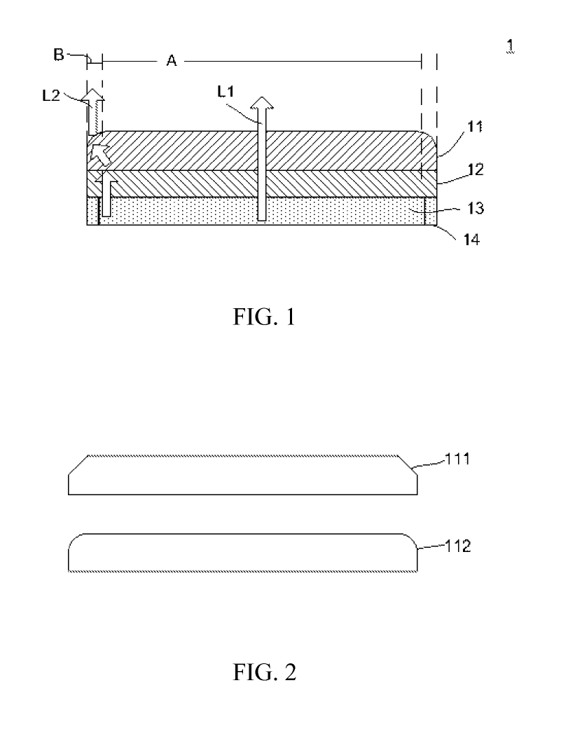

FIG. 1 shows a schematic diagram of a touch-sensitive display device according to an embodiment of the invention, where optical paths of image beams are indicated by arrows. Referring to FIG. 1, the touch-sensitive display device 1 includes a lens 11, a display 13, and a touch-sensitive element 12. The display 13 may be a liquid crystal display, an organic light-emitting diode display, a plasma display panel, or other type of display. The touch-sensitive element 12 is disposed between the lens 11 and the display 13, and the touch-sensitive element 12 may be a capacitive touch panel. The lens 11 is positioned above the touch-sensitive element 12, and a surface of the lens is divided into a central region A and a periphery region B. The periphery region B and the central region A have mutually different surface shapes. For instance, the central region A is in the shape of a planar surface, and the periphery region B is in the shape of a curved surface. The curved shape of the periphery region B of the lens 11 allows to deflect image beams from the display 13 when the image beams pass through the periphery region B. More specifically, the image beams passing through the periphery region A propagate in an original optical path L1, but the image beams passing through the periphery region B are deflected to propagate in a modified optical path L2. Hence, the border frame 14 of the display 13 is no longer seen by an observer to achieve the frameless visual effect. Further, the touch-sensitive element 12 between the lens 11 and the display 13 is capable of performing touch-sensitive operations, and this plus the frameless visual effect results in a frameless touch-sensitive display device.

FIG. 2 shows a schematic diagram illustrating different shapes of a lens. The shape of the periphery region of a lens may be selected according to the area of a border frame. For instance, referring to FIG. 2, a lens 111 having a periphery region in the shape of an inclined plane and a lens 112 having a periphery region in the shape of a curved surface are used in different embodiments. Further, the curved surface may a partial spherical surface or non-spherical surface. Besides, in case the periphery region is in the shape of an inclined plane, the slanted angle of the inclined plane may vary according to the area of the border frame. The lens 11 may be made of transparent plastic or transparent glass.

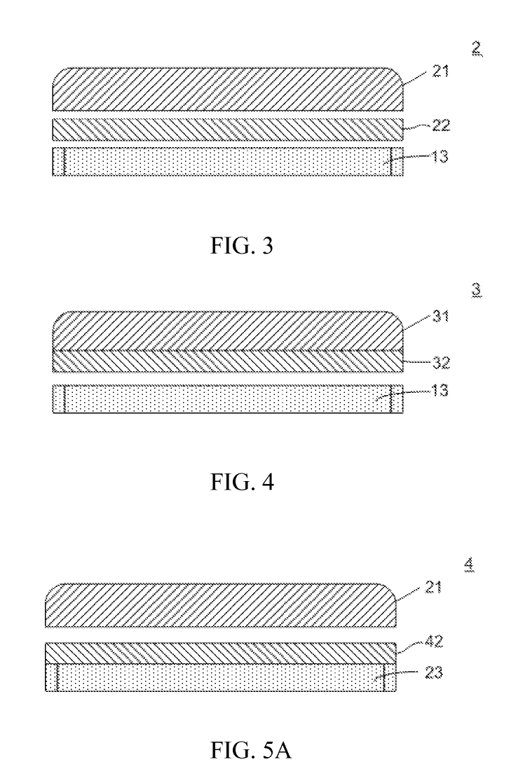

FIG. 3 and FIG. 4 each show schematic diagrams of a touch-sensitive display device according to another embodiment of the invention. Referring to FIG. 3, the touch-sensitive display device 2 may have a plug-in touch panel 22 disposed under a lens 21. Alternatively, referring to FIG. 4, in a touch-sensitive display device 3 a touch-sensitive element 32 is integrally formed under a lens 31 as one piece, with the lens 31 serving as a base plate and integrated with the touch-sensitive element 32. Further, in an alternate embodiment shown in FIG. 5A, in a touch-sensitive display device 4 a touch-sensitive element 42 is integrally formed on a display 23 as one piece, with the display 23 serving as a base plate and integrated with the touch-sensitive element 42. Also, referring to FIG. 5B, in a touch-sensitive display device 5 a touch-sensitive element 52 is integrally formed inside a display 33 as one piece, with the display 33 serving as a base plate. Note the touch-sensitive element may be a capacitive touch-sensitive element, a resistive touch-sensitive element, an optical touch-sensitive element, an ultrasonic touch-sensitive element, etc.

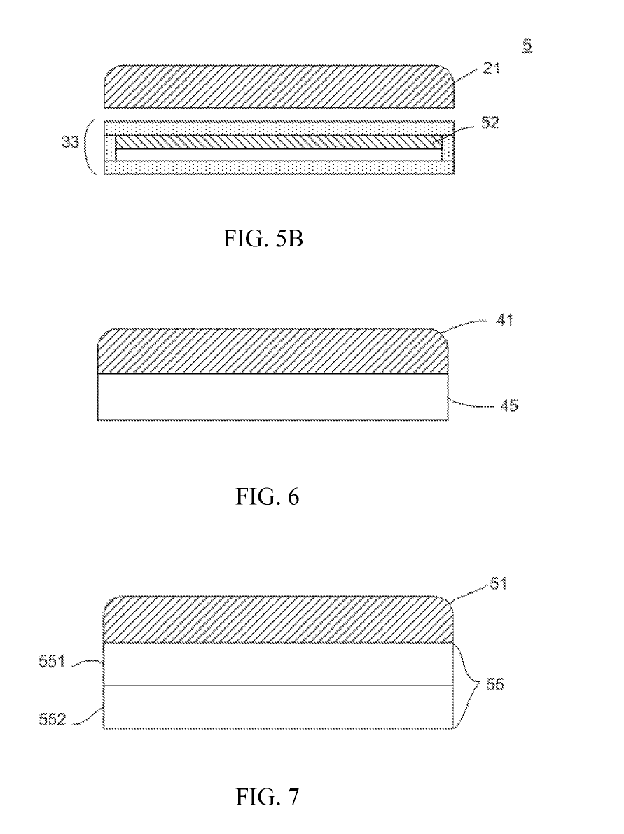

FIG. 6 shows a schematic diagram of a lens structure according to another embodiment of the invention. Referring to FIG. 6, in contrast to the embodiment shown in FIG. 1, the lens 41 is coated with an optical film 45 having high index of refraction on its one surface facing the touch-sensitive element, where the index of refraction of the optical film 45 is smaller than the index of refraction of the lens 41. The material of the lens 41 includes, but is not limited to, transparent glass or transparent plastic. The formation of an optical film allows to change the optical paths of image beams to a greater extent, thus reducing the lens thickness and overall occupied space. Similarly, the touch-sensitive display device in this embodiment may have a plug-in touch panel disposed under a lens, or a touch-sensitive element is integrally formed under a lens as one piece, with the lens serving as a base plate and integrated with the touch-sensitive element. Alternatively, a touch-sensitive element is integrally formed on a display as one piece, with the display serving as a base plate and integrated with the touch-sensitive element. The touch-sensitive element in this embodiment may be a capacitive touch-sensitive element, a resistive touch-sensitive element, an optical touch-sensitive element, an ultrasonic touch-sensitive element, etc.

FIG. 7 shows a schematic diagram of a lens structure according to another embodiment of the invention. Referring to FIG. 7, in contrast to the embodiment shown in FIG. 6, the lens 55 is coated with at least two optical films 55, and the optical film 55 that is more close to the lens 55 has a smaller index of refraction so as to change the paths of image beams to a greater extent. In this embodiment, the lens 55 is coated with a first optical film 551 and a second optical film 552, and the index of refraction of the first optical film 551 is smaller than that of the second optical film 552. Such design may further reduce the lens thickness and overall occupied space. Further, the material of the lens 51 includes, but is not limited to, transparent glass or transparent plastic. Similarly, the touch-sensitive display device in this embodiment may have a plug-in touch panel disposed under a lens, or a touch-sensitive element is integrally formed under a lens as one piece, with the lens serving as a base plate and integrated with the touch-sensitive element. Alternatively, a touch-sensitive element is integrally formed on a display as one piece, with the display serving as a base plate and integrated with the touch-sensitive element. The touch-sensitive element in this embodiment may be a capacitive touch-sensitive element, a resistive touch-sensitive element, an optical touch-sensitive element, an ultrasonic touch-sensitive element, etc.

Although the present invention has been fully described by the above embodiments, the embodiments should not constitute the limitation of the scope of the invention. Various modifications or changes can be made by those who are skilled in the art without deviating from the spirit of the invention.

What is claimed is:

1. A touch-sensitive display device, comprising:
a display having a display area for emitting image beams and a border frame beside the display area;
a lens disposed on the display, wherein a surface of the lens facing away from the display is divided into a periphery region and a central region, the central region overlaps the display area and is planar, and the periphery region overlaps the border frame and is non-planar;
at least one optical film formed on and in contact with one surface of the lens facing the display, wherein an index of refraction of the optical film is smaller than an index of refraction of the lens; and
a touch-sensitive element disposed between the optical film and the display, wherein a first refraction interface is formed between the touch-sensitive element and the optical film, a second refraction interface is formed between the optical film and the lens, the non-planar periphery region serves as a third refraction interface, and a part of the image beams passes through the first refraction interface, the second refraction interface, and the third refraction interface in succession.

2. The touch-sensitive display device as claimed in claim 1, wherein the periphery region of the lens forms a curved surface.

3. The touch-sensitive display device as claimed in claim 2, wherein the periphery region of the lens forms a partial spherical surface.

4. The touch-sensitive display device as claimed in claim 1, wherein the periphery region of the lens forms an inclined plane.

5. The touch-sensitive display device as claimed in claim 1, wherein the touch-sensitive element is integrally formed under the lens as one piece.

6. The touch-sensitive display device as claimed in claim 1, wherein the touch-sensitive element is integrally formed on the display as one piece.

7. The touch-sensitive display device as claimed in claim 1, wherein the touch-sensitive element is a capacitive touch-sensitive element, a resistive touch-sensitive element, an optical touch-sensitive element, or an ultrasonic touch-sensitive element.

8. A touch-sensitive display device, comprising:
a display having a display area for emitting image beams and a border frame beside the display area;
a lens disposed on the display, wherein a surface of the lens facing away from the display is divided into a periphery region and a central region, the central region overlaps the display area and is planar, and the periphery region overlaps the border frame and is non-planar;
a plurality of optical films formed on and in contact with one surface of the lens facing the display, wherein an optical film of the plurality of optical films that is more close to the lens has a smaller index of refraction; and
a touch-sensitive element disposed between the plurality of optical films and the display, wherein a first refraction interface is formed between the touch-sensitive element and the plurality of optical films, a second refraction interface is formed between the plurality of optical films and the lens, the non-planar periphery region serves as a third refraction interface, and a part of the image beams passes through the first refraction interface, the second refraction interface, and the third refraction interface in succession.

9. A touch-sensitive device, comprising:
a lens, wherein a surface of the lens is divided into a periphery region and a central region, the central region is bordered by the periphery region, the central region is planar, and the periphery region is non-planar;
at least one optical film formed on and in continuous contact with one surface of the lens, wherein an index of refraction of the optical film is smaller than an index of refraction of the lens; and
a touch-sensitive element disposed on the optical film, wherein a first refraction interface is formed between the touch-sensitive element and the optical film, a second refraction interface is formed between the optical film and the lens, the non-planar periphery region serves as a third refraction interface, and at least one image beam passes through the first refraction interface, the second refraction interface, and the third refraction interface in succession.

10. The touch-sensitive device as claimed in claim 9, wherein the image beam is emitted from a periphery of a display.

11. The touch-sensitive display device as claimed in claim 9, wherein the periphery region of the lens forms a curved surface.

12. The touch-sensitive display device as claimed in claim 11, wherein the periphery region of the lens forms a partial spherical surface.

13. The touch-sensitive display device as claimed in claim 9, wherein the periphery region of the lens forms an inclined plane.

14. The touch-sensitive display device as claimed in claim 9, wherein the touch-sensitive element is integrally formed under the lens as one piece.

15. The touch-sensitive display device as claimed in claim 9, wherein the touch-sensitive element is integrally formed on the display as one piece.

16. The touch-sensitive display device as claimed in claim 9, wherein the touch-sensitive element is a capacitive touch-sensitive element, a resistive touch-sensitive element, an optical touch-sensitive element, or an ultrasonic touch-sensitive element.
